(19) United States
(12) Patent Application Publication
(10) Pub. No.: US 2011/0164854 A1
(43) Pub. Date: Jul. 7, 2011

(54) FIBER DISTRIBUTION ENCLOSURE WITH EXTRACTABLE ORGANIZER

(76) Inventors: Christophe Desard, Herbignac (FR); Anthony Thepaut, Pontchateau (FR)

(21) Appl. No.: 13/061,970

(22) PCT Filed: Sep. 16, 2009
(86) PCT No.: PCT/US2009/057176

§ 371 Date: Mar. 3, 2011

Related U.S. Application Data
(60) Provisional application No. 61/099,321, filed on Sep. 23, 2008.

(51) Int. Cl. G02B 6/44

(52) U.S. Cl. 385/135

(57) ABSTRACT

An enclosure (100) for distributing optical fibers for communications includes a housing to house at least one optical fiber from a distribution cable and at least one drop fiber and an extractable fiber organizer (130) disposable in the housing. The extractable fiber organizer includes at least one splice tray (151a, b) rotatably coupled to a fiber ramp (140), the fiber ramp being detachably disposed in the housing. A fiber slack storage unit is disposed within the housing, the fiber slack storage unit including a fiber slack storage tray (122) configured to spool fiber slack. The ramp is configured to receive a distribution fiber (106a, b) and a drop fiber (108) from the fiber slack storage unit and guide the optical fibers to the at least one splice tray. The enclosure with the extractable fiber organizer allows the installer or service technician to work on fiber splices in a comfortable position, especially for an enclosure located in a riser closet or underground chamber.

### THE FIELD OF THE INVENTION

The present invention relates generally to an enclosure for distributing optical fibers for telecommunications, and in particular to an enclosure housing an extractable fiber organizer.

### BACKGROUND OF THE INVENTION

Telecommunication cables are used for distributing all manner of data across vast networks. A telecommunication cable typically includes a bundle of individual telecommunication lines (either optical fibers or copper wires) that are encased within a protective sheath. As telecommunication cables are routed across data networks, it is necessary to periodically open the cable so that one or more telecommunication lines therein may be spliced, thereby allowing data to be distributed to other cables or “branches” of the telecommunication network. The cable branches may be further distributed until the network reaches individual homes, businesses, offices, premises, and so on.

At each point where a telecommunication cable is opened, some type of enclosure is provided to protect the exposed interior of the cable. Commonly, the enclosure has one or more ports through which cables enter and/or exit the enclosure. Once inside the enclosure, the cable is opened to expose the telecommunication lines therein. Conventional telecommunication enclosures are constructed to facilitate the management and protection of individual telecommunication lines and splices thereof.

For some fiber-to-the-x (FTTX) deployments, a service provider typically installs an enclosure (also known as a fiber distribution terminal (FDT)) at the ground floor, on each floor, or every few floors of a multi-dwelling unit (MDU), residence, or business. The FDT connects the building riser cable to the horizontal drop cables which run to each living unit (in the MDU or on a particular floor). Drop cables are spliced to the riser cable in the FDT only as service is requested from a tenant in a living unit. Connecting existing MDUs to the FTTX network can often be difficult. Challenges can include gaining building access, limited distribution space in riser closets, and space for cable routing and management.

### SUMMARY OF THE INVENTION

In one aspect, an embodiment of the invention described herein provides an enclosure for distributing optical fibers for communications. The enclosure includes a housing to house at least one optical fiber from a distribution cable and at least one drop fiber and an extractable fiber organizer disposable in the housing. The extractable fiber organizer includes at least one splice tray rotatably coupled to a fiber ramp, the fiber ramp being detachably disposed in the housing. A fiber slack storage unit is disposed within the housing, the fiber slack storage unit including a fiber slack storage tray configured to spool fiber slack.

The above summary of the present invention is not intended to describe each illustrated embodiment or every implementation of the present invention. The figures and the detailed description that follows more particularly exemplify these embodiments.

### BRIEF DESCRIPTION OF THE DRAWINGS

Embodiments of the invention are better understood with reference to the following drawings. The elements of the drawings are not necessarily to scale relative to each other.

FIG. 1A is an isometric view of a fiber distribution enclosure according to an aspect of the present invention.

FIG. 1B is an isometric view of a fiber distribution enclosure having its splice trays in an operation position according to an aspect of the present invention.

FIG. 2A is an isometric view of a fiber distribution enclosure with the fiber organizer removed from the base unit according to an aspect of the present invention.

FIG. 2B is an isometric view of a mounting ramp portion of the extractable fiber organizer according to an aspect of the present invention.

FIG. 2C is an isometric view of a fiber distribution enclosure and riser cable positioned therein according to an aspect of the present invention.

FIG. 3 is an isometric view of a fiber distribution enclosure with a cover placed thereon according to an aspect of the present invention.

FIG. 4 is an exploded view of a cable sealing device according to another aspect of the present invention.

FIG. 5 is a view of an alternative grommet structure according to an alternative aspect of the present invention.

FIGS. 6A and 6B show different views of a cable entry device according to an alternative aspect of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention as defined by the appended claims.

### DESCRIPTION OF THE PREFERRED EMBODIMENTS

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “forward,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

The present invention is directed to a fiber distribution system which includes an enclosure housing an extractable fiber organizer that allows an installer or service technician more access to the fiber distribution point. In particular, the structure of the fiber distribution system with the extractable fiber organizer allows the installer or service technician to work on fiber splices in a comfortable position, especially for an enclosure located in a riser or underground chamber. Further, the extractable fiber organizer provides for a more straightforward way to add or remove a fiber drop without disturbing service to a different customer.

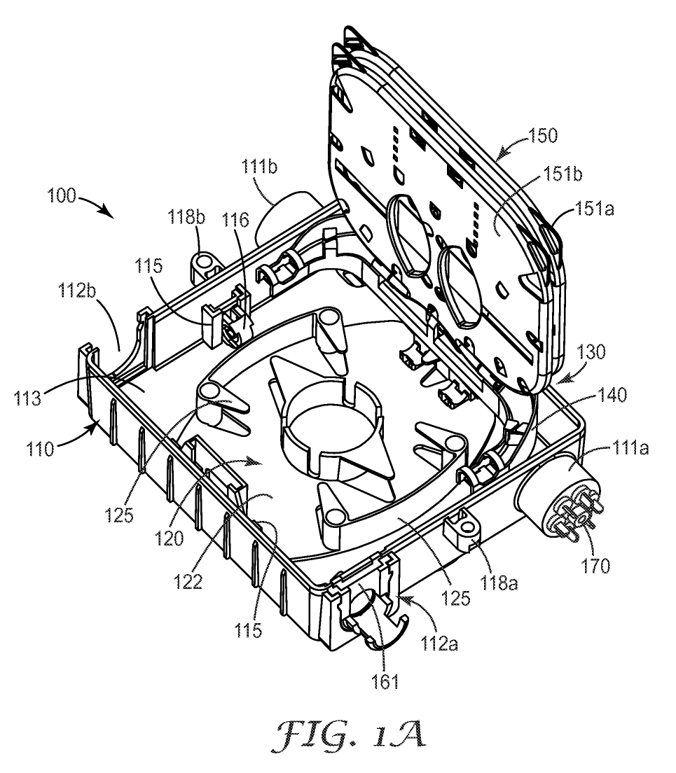

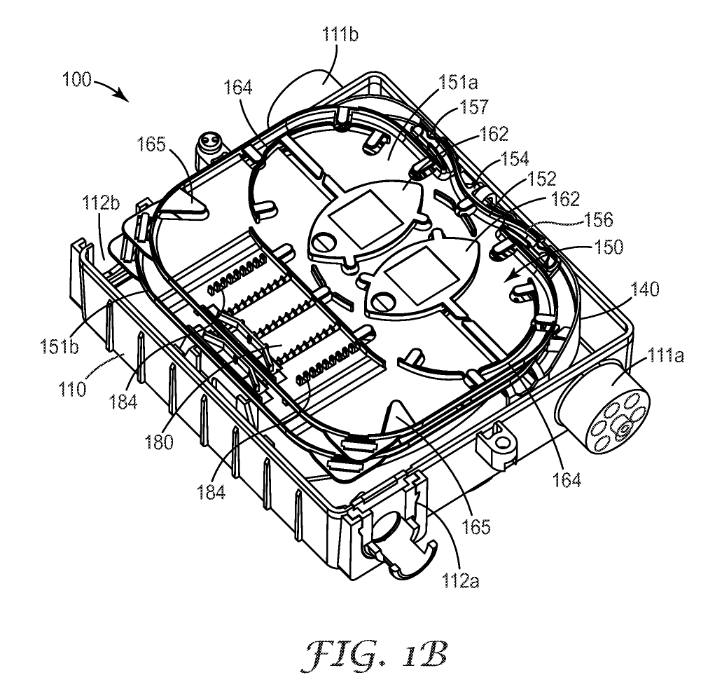

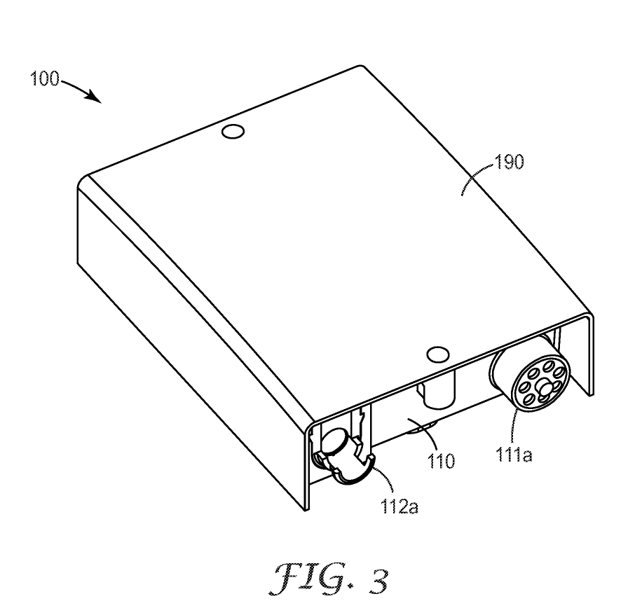

FIGS. 1A and 1B show an exemplary fiber distribution enclosure 100 (which can be referred to as a closure, a box, or a fiber distribution terminal (FDT)). Exemplary enclosure 100 (shown in FIG. 1A in an open state with the cover removed—see cover 190 in FIG. 3) includes a base unit 110 that is configured to house a fiber organizer 130. The fiber organizer 130 includes a splice tray section 150 that can include one or more exemplary splice trays (two splice trays 151a and 151b are shown in this example). The splice tray section 150 is coupled to a fiber ramp 140 that is removably coupled to the base unit 110. In other words, a technician or user may remove the fiber organizer 130 (including the ramp 140 and splice tray section 150) from the base unit 110 in a straightforward manner when needed.

As shown in FIGS. 1A and 1B, fiber distribution enclosure 100 has a multi-level structure, with a first level 130 configured for fiber organizing and a second level configured as a slack storage area 120 that is contained within a cavity region 113 of the base unit 110. The slack storage area 120 is configured to store excess drop cable fiber that is/can be coupled to a riser cable (not shown). A portion of the riser cable can be disposed in the enclosure 100, thus providing access to one or more individual communications fibers from the riser cable.

Enclosure 100 can take any standard shape. In a preferred aspect, the enclosure can take a rectangular shape of reduced dimensions in order to utilize the enclosure in areas that are space-limited. The various components of the enclosure 100, including the base, cover, slack storage and fiber organizer 130, and elements thereof, can be formed of any suitable material. The materials are selected depending upon the intended application and may include both polymers and metals. In one embodiment, the base and cover, and the other components, are formed of polymeric materials by methods such as injection molding, extrusion, casting, machining, and the like. Alternatively, components may be formed of metal by methods such as molding, casting, stamping, machining and the like. Material selection will depend upon factors including, but not limited to, chemical exposure conditions, environmental exposure conditions including temperature and humidity conditions, flame-retardancy requirements, material strength, and rigidity, to name a few.

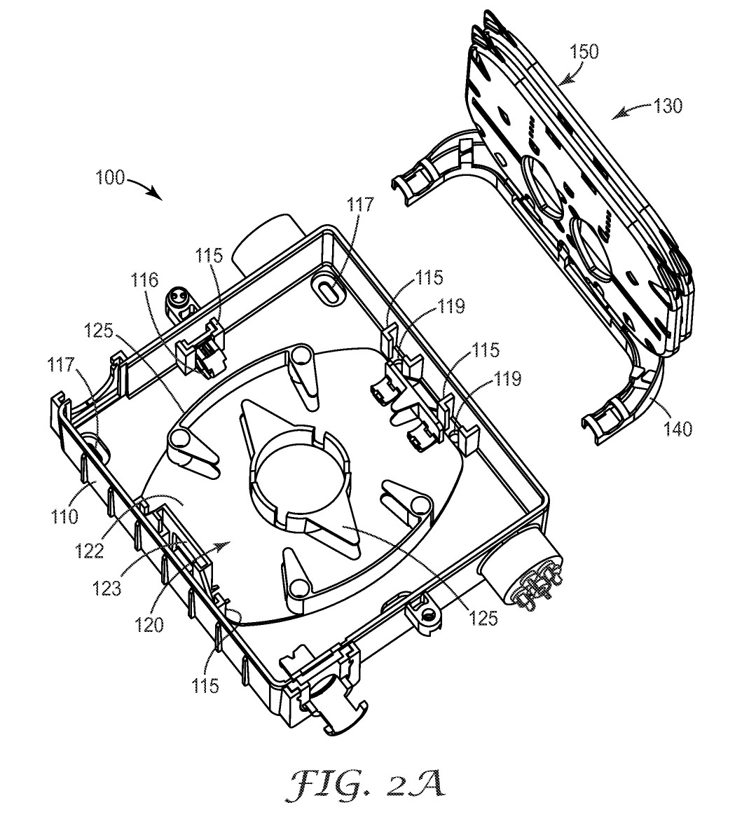

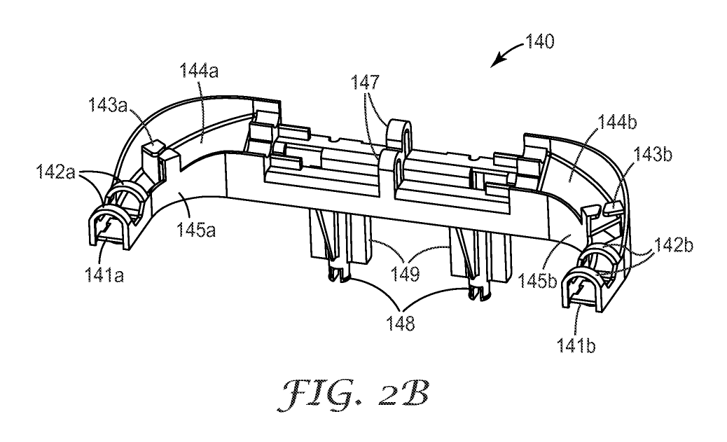

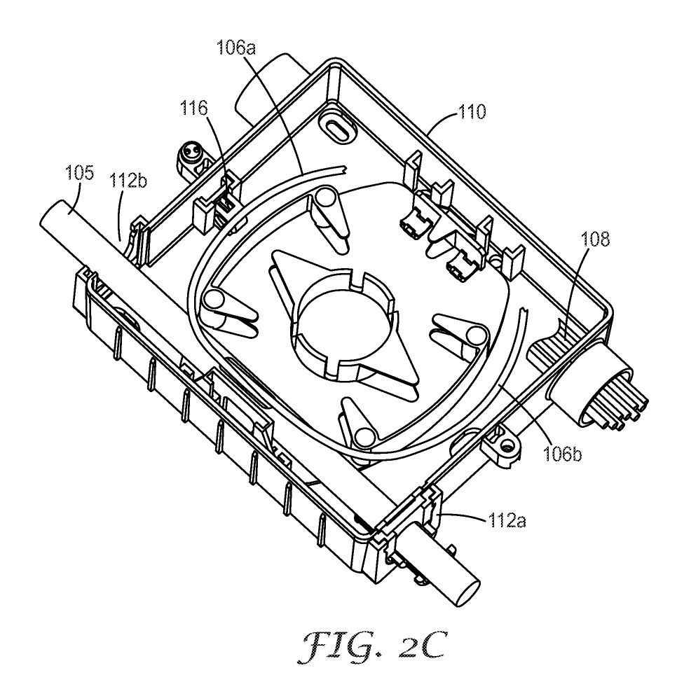

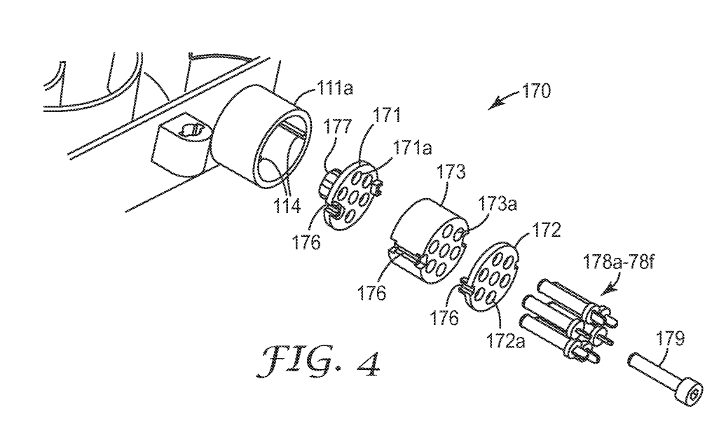

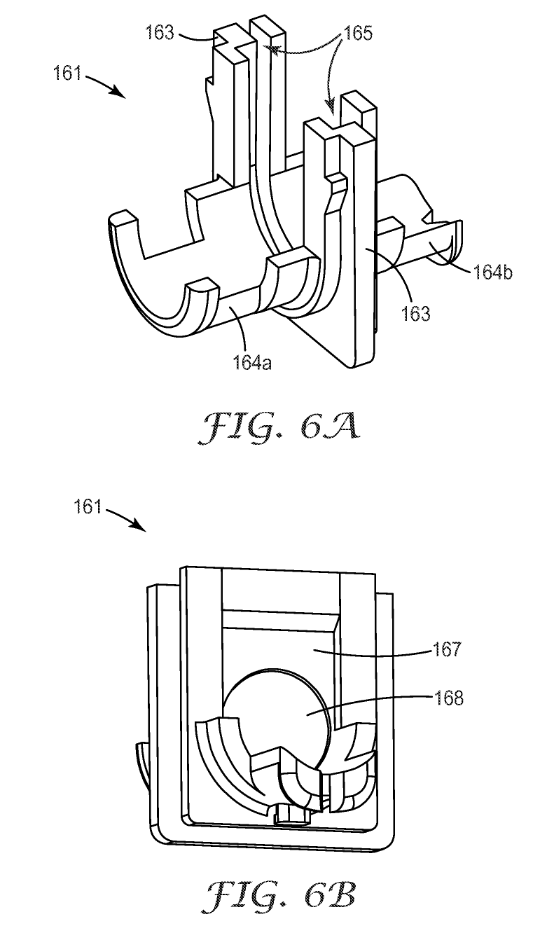

The base 110 of enclosure 100 can include one or more ports for receiving and distributing telecommunications cables. For example, as shown in FIG. 1A, one or more ports 111a, 111b, 112a, 112b can be configured to receive distribution/riser and drop cables. In this particular example, a distribution cable can enter and exit enclosure 100 in an in-line manner between ports 112a and 112b (see also FIG. 2C). The configuration of the cable entry device 161 used at ports 112a and 112b are described below in more detail with respect to FIGS. 6A and 6B. In addition, one or more ports 111a, 111b can be configured to allow passage of one or more drop cables which supply fiber to a particular customer or premise. The ports can allow passage of a single cable, or multiple cables, and optionally in combination with a holding or sealing member, such as exemplary sealing member 170, shown in more detail in FIG. 4. The base 110 may have one, two, or any other number ports as is required for a particular enclosure. In addition, the ports can be configured to receive standard cable inlet devices.

In one aspect, splice tray section 150 includes one or more exemplary splice trays 151a, 151b. For smaller size enclosures, the number of splice trays may be on the order of 1 to 8 splice trays. As would be understood by one of ordinary skill in the art given the present description, a larger sized base unit would accommodate a much greater number of splice trays. Splice trays 151a, 151b are provided so that, e.g., a distribution cable fiber can be connected to a drop cable fiber, or other cable fiber, to distribute the communications signal in an intended manner.

In a preferred aspect, the splice trays are rotatable. For example, in FIG. 1A, the splice trays 151a, 151b have been rotated to an upright position. In FIG. 1B, splice trays 151a, 151b are disposed in base unit in their normal operational position, in a stacked arrangement. As shown in FIG. 1B, exemplary splice tray 151a can be formed as a generally rectangular or oblong structure. Although the term “splice tray” is used throughout, as is described in more detail below, in alternative aspects, tray 151a, 151b can hold passive and/or active optical components, as well as splices.

In a preferred aspect, splice tray 151a (and the other splice trays of the enclosure) includes at least one latching mechanism that allows for rotation of the splice tray while secured to the mounting ramp 140. In more detail, splice tray 151a includes a latching mechanism 152 formed on an outer portion of the body of splice tray 151a. The latching mechanism can include a coupling portion 154 and one or more fiber entrance/exit channels 156, 157. Coupling portion 154 can be formed as a rod and can be coupled (e.g., by snap-fit) to hook portion 147 of the mounting ramp 140 (See FIG. 2B) to rotatably couple the splice tray 151a. Alternatively, as would be apparent to one of ordinary skill in the art given the present description, the coupling mechanism can have a different configuration.

In a preferred aspect, fiber entrance/exit channels 156, 157 are formed as extensions that extend away from the main splice tray body area. In addition, fiber entrance/exit channels 156, 157 can extend from the latching area in a slightly curved configuration to prevent potential kinks or unintended bends being placed on the entering/exiting fibers that are received by the splice tray.

In addition, fiber entrance/exit channels 156, 157 provide continual support to the entering/exiting fibers as the splice tray 151a is being rotated forward and backward. In a preferred aspect, channels 156, 157 are formed having a (relatively) deep “U” shape in cross-section, which supports fiber disposed therein even when the splice tray is fully tilted. Further, when latched, the fiber entrance/exit channels 156, 157 can extend into the fiber guiding channels 144a, 144b formed on the mounting ramp 140. Thus, fiber being routed to or from the splice tray can be continually supported.

Fiber from the distribution cable/drop cable is received in fiber entrance/exit channels 156, 157 and then routed to a splicing area 180. The splicing area 180 is configured to support mechanical and/or fusion splices made to the fiber. The mechanical or fusion splices can be of a single fiber or of a mass or ribbon fiber. For example, one or more fibers are guided to splicing portion 184 that is configured to securely hold one or more mechanical/fusion splices (e.g., via snug or snap fit). In one aspect, splicing portion 184 can comprise a number of resilient clips or other holders designed to hold one or more 4×4 FIBRLOK™ splices (commercially available from 3M Company, St. Paul Minn.). The splicing portion 184 can be formed as an integral portion of tray 151a. Alternatively, tray 151a can be formed with a cutout at splicing area 180 so that different splicing inserts can be mounted to the tray, depending on the application (e.g., an insert configured to support one or more fusion splices, or an insert to support one or more mechanical splices). In a preferred aspect, splicing area 180 is configured to secure one or more splices having either a 60 mm length or a 45 mm length.

In an alternative embodiment, the splicing area 180 can be configured to support a plurality of mechanical and/or fusion splices made in a stacked arrangement.

Fibers are routed to the splicing area via one or more fiber routing structures 162 that allow for changing the direction of the fiber in a straightforward manner (and without bending the fiber beyond its minimum bend radius). The fiber routing structures 162 can also provide some slack storage of the incoming/exiting fiber(s). Further fiber guiding structures 164 and tabs 165 can be formed in splice tray 151a to retain, route and support the fiber(s) being spliced.

In an alternative aspect, splicing area 180 can be configured to hold or secure any number of different passive and/or active optical components. For example, splicing area 180 can be configured to hold or secure one or more of 1×N fiber optic splitters, 2×N fiber optic splitters, WDM components, CWDM components, switches, multiplexers, triplexers, duplexers, detectors, mirrors, lasers, amplifiers, or combinations thereof.

In one embodiment, a first splice tray 151a can be configured to hold one or more splices and a second splice tray can be configured to hold one or more passive and/or active optical components. Also, each splice tray can further include a removable cover (not shown), such as a plastic, preferably transparent cover. Preferably, the cover can be mounted onto the splice tray via simple snap fit.

As mentioned above, in a preferred aspect, a technician or user may remove the fiber organizer 130 (including the ramp 140 and splice tray section 150) from the base unit 110 in a straightforward manner when needed. FIG. 2A shows the fiber organizer 130 removed from the base unit. In more detail, FIG. 2B shows a close up isometric view of the mounting ramp 140 which routes the distribution and drop fibers from the slack storage area 120 to the splice trays. Fibers enter and exit the mounting ramp 140 via entrance/exit portions 141a, 141b. In one aspect, the entrance/exit portions 141a, 141b further include retaining structures 142a, 142b to restrict excessive movement of the entering/exiting fibers. In one aspect, the retaining structures 142a, 142b are configured to snuggly receive a support gasket or tube (not shown) that snuggly retains the fibers and provides full radial support. In one exemplary aspect, a rubber tube snuggly retains the fibers at the entrance portions 141a and provides axial strain relief against inadvertent pulling forces.

The mounting ramp 140 further includes one or more fiber retention structures 143a and 143b disposed in ramp channels 144a, 144b for further fiber guidance and support. These ramp channels 144a, 144b are configured to guide the entering/exiting fibers around a modest bending region 145a/145b (not to exceed the minimum bend radius of the fiber(s) disposed therein) to/from the fiber entrance/exit channels 156, 157 of the splice tray(s) mounted thereon. In addition, as mentioned above, the coupling portion 154 (see FIG. 1B) of the splice tray(s) can be formed as a rod and can be coupled (e.g., by snap-fit) to hook portion(s) 147 of the mounting ramp 140 to rotatably couple the splice tray(s) to the enclosure.

In one aspect, the mounting ramp 140 is coupled to the base unit 110 via one or more mounting posts 148 (see FIG. 2B) configured to releasably engage (e.g., by simple interference or snap fit) holes 119 (see FIG. 2A) formed in base unit 110. The mounting posts 148 are guided towards holes 119 by one or more mounting slots 115 formed on one or more interior wall surfaces of the base unit 110. In this example, flange portions 149 of the mounting posts 148 are sliding received by mounting slots 115 (see FIG. 2A). In operation, a technician or user may remove the fiber organizer 130 from the enclosure by simply exerting a modest pulling force on the mounting ramp 140. In this manner, the technician or user may then place the removed organizer onto a working surface (such as a floor, ledge, shelf, workbench, or table) at a more convenient location at or near the enclosure 100.

As shown in the example of FIG. 2A, the base unit 110 can include multiple mounting slots 115 that are configured to receive additional enclosure components therein. For example, a slack storage tray 122 can be received within the cavity region 113 of the base unit 110. As shown in FIG. 2A, slack storage tray 122 includes a handle 123 that is configured to be slidably received by one or more mounting slots 115. The slack storage area 120 of the enclosure includes a slack storage tray 122 that has one or more fiber routing structures 125 to help spool excess drop and distribution fiber within the enclosure. In a preferred aspect, the slack storage tray 122 can store from about 0.5 meter to about three meters of excess fiber. The slack storage tray 122 can also be removable from the base unit 110 so that the fiber organizer and slack storage tray can be removed for splicing and other operations.

Additional fiber retention within the cavity 113 of the base unit can be provided by use of one or more fiber anchors 116. The anchor device(s) 116 wrap around and grasp the fiber(s) to form a bundle and are retained in place through mounting the anchor(s) into a mounting slot(s) 115. Thus, a fiber bundle can be maintained or retained within the slack storage area of the enclosure while in operation. If a technician needs to re-enter the enclosure to add a drop or remove a drop, the fiber bundle held by the anchor(s) 116 is easily accessible and is removable, as is the slack storage tray 122.

Also, as is shown in FIG. 2A, base unit 110 can be mounted to a wall or other surface via one or more mount holes 117 that are configured to receive conventional fasteners or wall mounts.

As shown in FIG. 2C, the base unit 110 of the enclosure can accommodate a standard riser cable, such as riser cable 105, in an in-line manner, as a portion of cable 105 is disposed between ports 112a and 112b. One or more distribution fibers 106a, 106b may be removed from cable 105 to be spliced with one or more drop fibers 108. The fibers can be standard optical telecommunications fibers, for example, fibers having a standard optical fiber buffer cladding, such as a 900 μm outer diameter buffer cladding, a 250 μm buffer cladding, or a fiber buffer cladding having an outer diameter being larger or smaller.

As mentioned above, enclosure 100 includes a cover to protect the contents of the enclosure. In one aspect, in FIG. 3, an exemplary cover 190 is provided. The cover 190 can be fastened to the base unit 110 via conventional fasteners, such as screws, for mounting onto one or more screw-holes 118a, 118b (see FIG. 1A). Alternative fastening devices could also be used, as would be apparent to one of skill in the art given the present description.

Drop fibers can enter/exit the enclosure 100 via one or more ports, such as ports 111a or 111b shown in FIG. 1A. An exemplary fiber retention or sealing member 170, such as is shown in FIG. 4, can be utilized to retain one or more drop fibers. The fiber retention or sealing cap 170 can include a grommet 173 that includes a plurality of lengthwise extending holes 173a that receive and guide a plurality of fibers through the grommet 173. The grommet preferably comprises a resilient material, such as a rubber-based material. The fiber retention or sealing cap 170 can further include first and second abutment members 171, 172, that cap the first and second ends of the grommet 173. Each abutment member includes a corresponding plurality of holes 171a, 172a (i.e., corresponding to the holes 173a formed in the gasket 173) to further receive and guide the plurality of fibers. For alignment purposes, one or both of the abutment members, as well as the sealing member, includes one or more guide slots 176 which are configured to engage the keys or protrusions 114 formed on the inner wall(s) of the port 111a. Optionally, one or more plugs (in this example, plugs 178a-178f) can be utilized to fill the unused fiber guide holes when unoccupied by a drop fiber.

In addition, one of the abutment members further includes a threaded receptacle 177 configured to receive a locking screw 179. In operation, the locking screw 179 is turned and compresses the grommet 173 between the abutment members, causing a radial expansion of the grommet against the inner wall(s) of the port 111a and around the perimeter of any cables or plugs inserted therein.

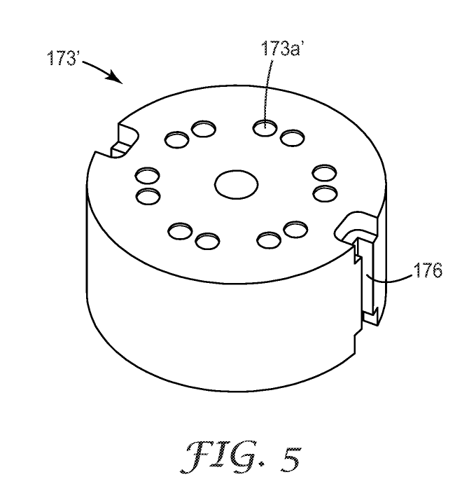

In an alternative aspect, a grommet 173′ can be configured as is shown in FIG. 5. In this alternative aspect, the grommet is formed of a resilient material where each of the fiber guiding holes 173a′ is covered by a thin membrane of material until perforated when the drop fiber is inserted therethrough. Also, each of the fiber guiding holes 173a′ of grommet 173′ can be configured to receive smaller diameter fibers/cables. In this aspect, two fibers/cables can be inserted through each hole formed in the abutment members.

Ports 112a and 112b are utilized to provide an entrance and an exit for riser cable 105. FIGS. 6A and 6B provide detailed views of an exemplary cable entry device 161 that can be disposed at ports 112a and 112b. In a preferred aspect, each of the cable ports 112a, 112b (see FIG. 1A) is fitted with a slotted portion to slidingly receive a corresponding body portion 163 of the cable entry device. Cable entry device 161 also includes one or more cable support structures 164a, 164b to support the entering/exiting cable. Each of the cable support structures 164a, 164b can include extensions that provide straightforward cable securing using a conventional cable tie or cable clamp. In this manner, axial strain on the riser cable can be greatly reduced. In addition, the cable entry device 161 includes a cover plate or gasket 167 that is slidingly received by the slots 165 formed in the body 163 of the cable entry device. The cover plate or gasket 167 includes a punch-out and/or cut-out portion 168 to surround the riser cable perimeter and reduce the ingress of outside elements from entering the enclosure. A simple cut can be made in the cover plate or gasket 167 (e.g., at the bottom portion of the gasket) to allow the cover plate or gasket 167 to be placed over and surround the perimeter of the riser cable.

As mentioned above, the structure of the fiber distribution system with the extractable fiber organizer, such as is shown above in FIGS. 1A-1B and 2A-2C, allows the installer or service technician to work on fiber splices in a comfortable position, especially for an enclosure located in a riser or underground chamber. For example, in operation (using the reference numbers described above as an illustration), the base unit 110 of the enclosure can be mounted or fastened to a room or cabinet wall in a riser or other communications station at or within a building or premise. The distribution fibers and the drop line(s) 108 can be guided in the same direction and bundled together with the fiber anchor 116. The fiber organizer can be removed from the enclosure and placed on a working space remote from the enclosure. The fibers to be spliced can be prepared (i.e., having the jacket/buffer removed, stripped, etc.) then routed to one of the splice trays. The splicing operation can be accomplished using a conventional mechanical or fusion splicing procedure.

After splicing of the fiber or fibers, excess fiber can be spooled inside the slack storage area. The cable entry ports can be secured. The fiber organizer 130 can be returned to the enclosure and the anchor can be mounted inside the base unit via one of the mounting slots 115. The spice tray(s) can be tilted to its/their normal use position, and the cover 190 can be mounted onto the base unit. If an installer needs to re-enter the enclosure, the fiber bundle can be removed, as well as the fiber organizer and, in some cases, the slack storage tray. A drop fiber can be added through the entry port grommet and the new drop can be spliced in the same manner as described earlier. The components can then be returned to their positions as before.

Thus, the embodiments of the present invention are directed to a compact fiber distribution enclosure that includes an extractable fiber organizer that provides for a more straightforward way to add or remove a fiber drop without disturbing service to a different customer.

Although specific embodiments have been illustrated and described herein for purposes of description of the preferred embodiment, it will be appreciated by those of ordinary skill in the art that a wide variety of alternate or equivalent implementations may be substituted for the specific embodiments shown and described without departing from the scope of the present invention. Those with skill in the art will readily appreciate that the present invention may be implemented in a very wide variety of embodiments. This application is intended to cover any adaptations or variations of the embodiments discussed herein.

1. An enclosure for distributing optical fibers for communications, comprising:
a housing to house at least one optical fiber from a distribution cable and at least one drop fiber;
an extractable fiber organizer disposable in the housing, the extractable fiber organizer including at least one splice tray rotatably coupled to a fiber ramp, the fiber ramp being detachably disposed in the housing; and
a fiber slack storage unit disposed within the housing, the fiber slack storage unit including a fiber slack storage tray configured to spool fiber slack, wherein the ramp is configured to receive a distribution fiber and a drop fiber from the fiber slack storage unit and guide the optical fibers to the at least one splice tray.

2. The enclosure of claim 1, further comprising a fiber anchor configured to secure the distribution fiber and the drop fiber in a bundle, the anchor slidably receivable in a mounting slot formed on an interior wall of the housing.

3. The enclosure of claim 1, wherein the fiber ramp includes:
a fiber entrance portion and a fiber exit portion, wherein each portion includes a retaining structure to restrict excessive movement of the entering or exiting fiber;
first and second ramp channels to guide the entering or exiting fibers around a bending region to the at least one splice tray; and
one or more mounting posts configured to releasably engage one or more receiving holes formed in housing.

4. The enclosure of claim 3, wherein the one or more mounting posts are guided towards the one or more receiving holes via one or more mounting slots formed on one or more interior wall surfaces of the housing.

5. The enclosure of claim 3, further comprising support gasket disposed in the retaining structure, the gasket configured to snuggly retain the entering or exiting fiber and to provide radial support.

6. The enclosure of claim 1, wherein the at least one splice tray includes a latching mechanism rotatably engageable with the ramp and disposed on an outer portion of the splice tray, wherein the latching mechanism includes a coupling portion and one or more fiber entrance/exit channels that are formed as an extension that extends away from a main splice tray body area, wherein each of the one or more fiber entrance/exit channels extends to a position proximate to a respective fiber guiding channel formed on the fiber circuit platform.

7. The enclosure of claim 6, wherein the one or more fiber entrance/exit channels of the at least one splice tray extend in a slightly curved configuration.

8. The enclosure of claim 1, wherein the splice tray includes a splicing area, wherein the splicing area is configured to support at least one of 1×N fiber optic splitters, 2×N fiber optic splitters, WDM components, CWDM components, and combinations thereof.

9. The enclosure of claim 1, wherein the splice tray includes a splicing area configured to support at least one of a mechanical splice and a fusion splice.

10. The enclosure of claim 1, wherein the at least one splice tray comprises a plurality of splice trays disposed in a stacked arrangement disposed within the enclosure.

11. The enclosure of claim 1, wherein the enclosure includes a first set of ports disposed on opposite walls of the housing configured to mount a fiber distribution cable in an in-line manner.

12. The enclosure of claim 11, wherein the enclosure further comprises an additional port configured to receive a plurality drop fibers.

13. The enclosure of claim 12, wherein the drop fibers are secured to a cable sealing member, the cable sealing member including a resilient grommet having a plurality of lengthwise extending holes that receive and guide the plurality of drop fibers, and further including first and second abutment members that cap the first and second ends of the grommet, wherein each abutment member includes a corresponding plurality of holes to further receive and guide the plurality of drop fibers, wherein one of the abutment members further includes a threaded receptacle configured to receive a locking screw.
